(19) United States
(12) Patent Application Publication
(10) Pub. No.: US 2021/0044158 A1
(43) Pub. Date: Feb. 11, 2021

(54) WIRELESS CHARGING DEVICE AND WIRELESS CHARGING METHOD

(71) Applicant: BOE TECHNOLOGY GROUP CO., LTD., Beijing (CN)

(72) Inventor: Wei DENG, Beijing (CN)

(73) Assignee: BOE TECHNOLOGY GROUP CO., LTD., Beijing (CN)

(21) Appl. No.: 16/977,864

(22) PCT Filed: Dec. 26, 2019
(86) PCT No.: PCT/CN2019/128765

§ 371 Date: Sep. 3, 2020

(30) Foreign Application Priority Data
Jan. 2, 2019 (CN) 201910001613.X

(51) Int. Cl. H02J 50/90; G08B 5/36; H02J 7/02; H02J 50/10; H02J 7/00; H02J 50/80

(52) U.S. Cl. CPC H02J 50/90; G08B 5/36; H02J 50/80; H02J 50/10; H02J 7/00032; H02J 7/02

(57) ABSTRACT

A wireless charging device and a wireless charging method are provided. The wireless charging device includes a transmit coil, a first communicator, an indicator and a controller. The first communicator is configured to receive equipment information of an equipment to be charged; the controller is configured to acquire relative position information of a receive coil of the equipment to be charged according to the equipment information, and control the indicator to send out prompt information according to the relative position information to indicate a placement position of the equipment to be charged.

The present application claims the priority of Chinese patent application No. 201910001613.X filed on Jan. 2, 2019, the entire disclosure of the aforementioned application is incorporated by reference as part of the disclosure of this application.

### TECHNICAL FIELD

Embodiments of the present disclosure relate to a wireless charging device and a wireless charging method.

### BACKGROUND

With the advent of the information age, the application of electronic products has become more and more popular, especially portable electronic products that have brought great convenience to people. Wireless charging can not only reduce the inconvenience of carrying a data cable, but also facilitate a waterproof and dustproof design of the product because an additional charging port for a portable electronic product is not required to be reserved.

### SUMMARY

At least an embodiment of the present disclosure provides a wireless charging device, comprising a transmit coil, a first communicator, an indicator and a controller. The transmit coil is configured to receive equipment information of an equipment to be charged; and the controller is configured to acquire relative position information of a receive coil of the equipment to be charged according to the equipment information, and control the indicator to send out prompt information according to the relative position information to indicate a placement position of the equipment to be charged.

In some examples, the wireless charging device further comprises a bearing surface, and the bearing surface is used to support the equipment to be charged; the prompt information comprises a light projection on the bearing surface, and the light projection is used to define the placement position of the equipment to be charged.

In some examples, the indicator comprises a light-emitting element which is configured to emit light under control of the controller and project the light onto the bearing surface to form the light projection.

In some examples, the placement position of the equipment to be charged is a rectangular region, and the light projection comprises at least two linear light projections to indicate at least two sides of the rectangular region; and the light-emitting element comprises at least two line light sources, and the at least two line light sources are respectively configured to form the at least two linear light projections.

In some examples, the at least two line light sources are respectively configured to emit light of different colors to indicate a placement direction of the equipment to be charged.

In some examples, each of the at least two line light sources comprises a light guide pole, and the light guide pole is arranged parallel to the bearing surface; and a surface of the light guide pole is provided with an opaque coating having a slit, so that light emitted from the light guide pole is restricted to a single direction to form the line light source.

In some examples, the indicator further comprises at least two rotators, the at least two rotators are arranged in a one-to-one correspondence with the at least two line light sources, and each of the at least two rotators is configured to rotate a corresponding line light source to change a light output direction of the corresponding line light source; and the controller is further configured to control each of the at least two rotators to rotate the corresponding line light source according to the relative position information of the receive coil, so as to change a position of a linear projection formed by the corresponding line light source on the bearing surface, thereby indicating the placement position of the equipment to be charged.

In some examples, the light-emitting element is configured to project light from a side, close to the transmit coil, of the bearing surface to the bearing surface to form the light projection.

In some examples, the light-emitting element is configured to project light from a side, away from the transmit coil, of the bearing surface to the bearing surface to form the light projection.

In some examples, the indicator further comprises a retractor, and the retractor is located on a side, close to the transmit coil, of the bearing surface; and the retractor is connected to the light-emitting element and allows the retractor to protrude relative to the bearing surface and to have a variable distance from the bearing surface.

In some examples, the wireless charging device further comprises a device body having the bearing surface, the device body comprises a cavity, and the cavity is used for accommodating the transmit coil, the first communicator, the controller, and the indicator.

In some examples, the wireless charging device further comprises a memory, and the memory is configured to store the equipment information of the equipment to be charged and the relative position information, associated with the equipment information, of the receive coil.

In some examples, the controller is configured to acquire the relative position information of the receive coil of the equipment to be charged from the memory, or to control the first communicator to acquire the relative position information of the receive coil of the equipment to be charged from a network according to the equipment information of the equipment to be charged.

In some examples, the wireless charging device further comprises a sensor, and the sensor is configured to sense whether an equipment to be charged approaches the wireless charging device; and the first communicator is further configured to acquire the equipment information of the equipment to be charged from the equipment to be charged in a case where the equipment to be charged approaches the wireless charging device.

At least an embodiment of the present disclosure further provides a wireless charging method, comprising: receiving equipment information of an equipment to be charged; acquiring relative position information of a receive coil of the equipment to be charged according to the equipment information; and sending out prompt information according to the relative position information to indicate a placement position of the equipment to be charged.

In some examples, sending out prompt information according to the relative position information comprises: controlling a light-emitting element to emit light and project the light onto a bearing surface, for placing the equipment to be charged, of the wireless charging device to form a light projection according to the relative position information of the receive coil, wherein the light projection defines the placement position of the equipment to be charged.

In some examples, the placement position of the equipment to be charged is a rectangular region, and the light-emitting element comprises at least two line light sources; controlling the light-emitting element to emit light and project the light onto the bearing surface, for placing the equipment to be charged, of the wireless charging device to form the light projection according to the relative position information of the receive coil comprises: controlling the at least two line light sources to form at least two linear projections on the bearing surface to indicate at least two sides of the rectangular region.

In some examples, controlling the at least two line light sources to form at least two linear projections on the bearing surface to indicate at least two sides of the rectangular region comprises: controlling the at least two line light sources to rotate according to the relative position information of the receive coil, so as to change light output directions of the at least two line light sources and positions of the linear projections formed on the bearing surface, thereby indicating the placement position of the equipment to be charged.

In some examples, controlling the light-emitting element to emit light and project the light onto the bearing surface, for placing the equipment to be charged, of the wireless charging device to form the light projection according to the relative position information of the receive coil further comprises: controlling the at least two line light sources to emit light of different colors to indicate a placement direction of the equipment to be charged.

In some examples, acquiring the relative position information of the receive coil according to the equipment information further comprises: acquiring the relative position information of the receive coil of the equipment to be charged from a memory; or controlling a first communicator to acquire the relative position information of the receive coil of the equipment to be charged from a network according to the equipment information of the equipment to be charged.

In some examples, the method further comprises: sensing whether an equipment to be charged approaches the wireless charging device; and acquiring the equipment information of the equipment to be charged from the equipment to be charged in a case where the equipment to be charged approaches the wireless charging device.

### BRIEF DESCRIPTION OF THE DRAWINGS

In order to clearly illustrate the technical solution of the embodiments of the present disclosure, the drawings of the embodiments will be briefly described in the following. It is obvious that the described drawings in the following are only related to some embodiments of the present disclosure and thus are not limitative of the present disclosure.

FIG. 1 is a schematic block diagram of a wireless charging device provided by at least one embodiment of the present disclosure;

FIG. 2 is a schematic diagram of an equipment to be charged provided by at least one embodiment of the present disclosure;

FIG. 3A is a schematic sectional structural diagram of a wireless charging device provided by at least one embodiment of the present disclosure;

FIG. 3B is a schematic structural diagram of a top view of a wireless charging device provided by at least one embodiment of the present disclosure;

FIG. 4 is a schematic plan view of a wireless charging device provided by some other embodiments of the present disclosure;

FIG. 5A-FIG. 5B are an example of a cross-sectional view of FIG. 4 along the section line A-A′;

FIG. 5C is an example of a cross-sectional view of FIG. 4 along the section line B-B′;

FIG. 6A is another example of a cross-sectional view of FIG. 4 along the section line A-A′;

FIG. 6B is another example of a cross-sectional view of FIG. 4 along the section line B-B′;

FIG. 7A is still another example of a cross-sectional view of FIG. 4 along the section line A-A′;

FIG. 7B is still another example of a cross-sectional view of FIG. 4 along the section line B-B′;

FIG. 8A-FIG. 8B illustrate schematic diagrams of a wireless charging device in operation provided by at least one embodiment of the present disclosure;

FIG. 9 is a schematic calculation diagram of an alignment method in an embodiment of the present disclosure;

FIG. 10 is a schematic diagram of calculation of a rotation angle of a light guide pole in an embodiment of the present disclosure;

FIG. 11A is a schematic diagram of a planar structure of a wireless charging device provided by still another embodiments of the present disclosure;

FIG. 11B is a schematic sectional structural diagram of the wireless charging device in FIG. 11A;

FIG. 11C is another schematic sectional structural diagram of the wireless charging device in FIG. 11A;

FIG. 12A is a first schematic flowchart of a wireless charging method provided by at least one embodiment of the present disclosure;

FIG. 12B is a second schematic flowchart of a wireless charging method provided by at least one embodiment of the present disclosure; and

FIG. 13 is a schematic structural diagram of an electronic equipment provided by at least one embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first”, “second”, etc., which are used in the description and the claims of the present application for disclosure, are not intended to indicate any sequence, amount or importance, but distinguish various components. The terms “comprise”, “comprising”, “include”, “including”, etc., are intended to specify that the elements or the objects stated before these terms encompass the elements or the objects and equivalents thereof listed after these terms, but do not preclude the other elements or objects. “On”, “under”, “right”, “left” and the like are only used to indicate relative position relationship, and when the position of the object which is described is changed, the relative position relationship may be changed accordingly.

In the process of wireless charging design and application, whether a transmit coil of a charging equipment is aligned with a receive coil of an equipment to be charged has a great influence on the efficiency of wireless charging. In the actual process of using, due to the different positions of the receive coil in the equipment to be charged, the receive coil is offset from the transmit coil when a user places the equipment to be charged. Therefore, it is of great significance to remind the user of the placement position of the equipment to be charged to improve the efficiency of wireless charging.

At least one embodiment of the present disclosure provides a wireless charging device, which can solve the alignment problem of the receive coil and the transmit coil in wireless charging to some extent.

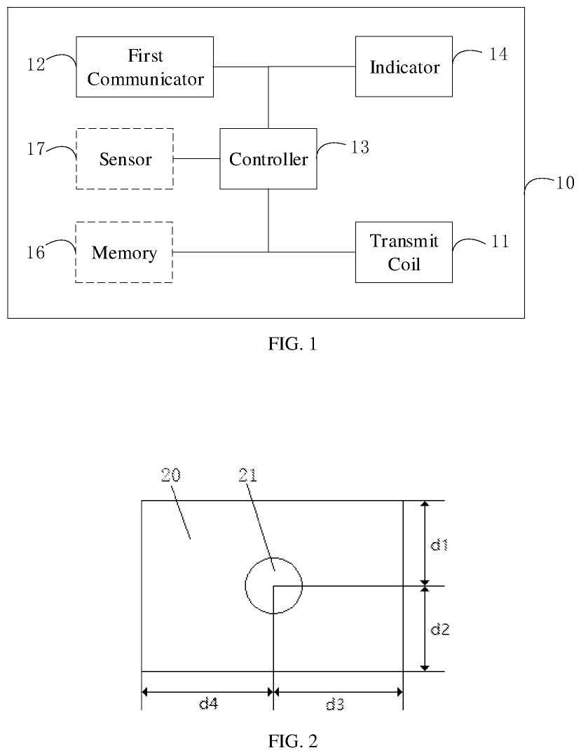

FIG. 1 is a schematic block diagram of a wireless charging device provided by at least one embodiment of the present disclosure. As illustrated in FIG. 1, the wireless charging device 10 includes a transmit coil 11, a first communicator 12, a controller 13 and an indicator 14. The first communicator 12 is configured to receive equipment information of an equipment 20 to be charged. The equipment information includes, for example, information such as model information and physical address (MAC address) of the equipment to be charged. The identity of the equipment to be charged 20 can be determined according to the equipment information, so as to obtain information such as the shape and size of the equipment to be charged 20, and obtain relative position information of the receive coil of the equipment to be charged in the equipment to be charged. The embodiments of the present disclosure do not limit the type of the equipment to be charged, for example, the equipment including, but not limited to, a mobile phone, a tablet computer, an e-book, and the like. For example, in the case where the equipment to be charged 20 is a mobile phone, the equipment information may include model information such as iPhone X, iPhone Xs max, or the like.

For example, the first communicator 12 can wirelessly communicate with the equipment to be charged 20 or other electronic equipment through a wireless connection via a network, such as the Internet, an intranet, and/or a wireless network such as a cellular telephone network, a wireless local area network (LAN) and/or a metropolitan area network (MAN). Wireless communication can use any one of a variety of communication standards, protocols and technologies, including but not limited to Global System for Mobile Communications (GSM), Enhanced Data GSM Environment (EDGE), Wideband Code Division Multiple Access (W-CDMA), Code Division Multiple Access (CDMA), Time Division Multiple Access (TDMA), Bluetooth, Wi-Fi (for example based on IEEE 802.11a, IEEE 802.11b, IEEE 802.11g and/or IEEE 802.11n standards), Voice over Internet Protocol (VoIP), Wi-MAX, protocols for email, instant messaging and/or Short Message Service (SMS), or any other applicable communication protocols.

The controller 13 is configured to acquire a relative position information of a receive coil 21 of the equipment to be charged 20 in the equipment to be charged 20 (referring to FIG. 2) according to the equipment information, and control the indicator 14 to send out prompt information according to the relative position information to indicate a placement position of the equipment to be charged 20, so as to allow the transmit coil 11 and the receive coil 21 to be aligned.

For example, the controller 13 can be hardware, software, firmware, and any feasible combination thereof. For example, the controller 13 can be a dedicated or general-purpose circuit, chip or device, etc., or can be a combination of a processor and a memory.

For example, the processor can be a central processing unit (CPU), a graphics processing unit (GPU), a digital signal processor (DSP), or other forms of processing units with data processing capabilities and/or program execution capabilities, such as field programmable gate array (FPGA), etc.; for example, the central processing unit (CPU) can be X86 or ARM architecture. The processor can be a general-purpose processor or a dedicated processor, and can control other components in the wireless charging device 10 to perform desired functions.

For example, the memory can include any combination of one or more computer program products, and the computer program product can include various forms of computer-readable storage media, such as volatile memory and/or non-volatile memory. The volatile memory can include, for example, random access memory (RAM) and/or cache memory (cache), etc. The non-volatile memory can include, for example, read only memory (ROM), hard disk, erasable programmable read only memory (EPROM), portable compact disk read only memory (CD-ROM), USB memory, flash memory, etc. Computer program instructions, such as one or more computer program modules, can be stored in the computer-readable storage medium, and the processor can run the computer program instructions to implement various functions of the controller 13. The computer-readable storage medium can further store various application programs and various data, various data used and/or generated by the application programs, and the like.

For example, as illustrated in FIG. 2, the relative position information refers to the position of the receive coil 21 in the equipment to be charged 20, and can further include a coordinate information of the receive coil 21 in a coordinate system, which is established with the center or a corner of the equipment to be charged 20 as the coordinate origin. For example, in the case where the equipment to be charged 20 is a quadrangle, such as a rectangle, the relative position information of the receive coil 21 includes the vertical distances from the center of the receive coil 21 to the four sides of the equipment to be charged. As illustrated in FIG. 2, the relative position information may also refer to the vertical distances d1, d2, d3, and d4 between the center of the receive coil 21 and the four sides of the equipment to be charged 20. For example, the relative position information of the receive coil includes the size information of the equipment to be charged. For example, the relative position information can be retrieved by the wireless charging device from its local storage or acquired from the network according to the equipment information.

It can be seen from the above embodiments that the wireless charging device provided by the embodiments of the present disclosure acquires corresponding relative position information by receiving the equipment information of the equipment to be charged, and controls the indicator to send out prompt information to indicate the placement position of the equipment to be charged for the purpose of aligning the transmit coil with the receive coil. In this way, when the user places the equipment to be charged in the placement position, coil alignment can be achieved, thereby improving charging efficiency.

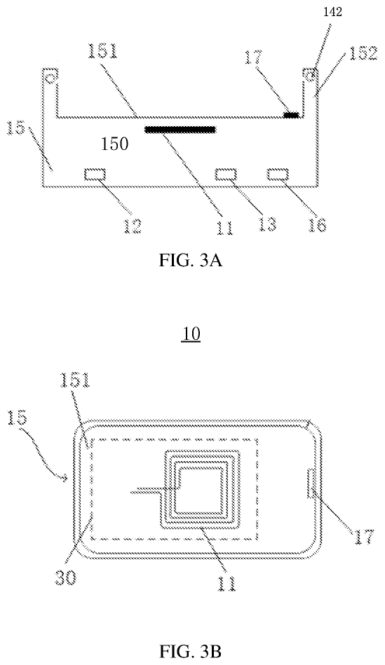

FIG. 3B and FIG. 3A respectively illustrate an example of a schematic plan view and a cross-sectional view of a wireless charging device provided by at least one embodiment of the present disclosure. As illustrated in FIG. 3A and FIG. 3B, the wireless charging device 10 further includes a bearing surface 151, and the bearing surface 151 is configured to support the equipment to be charged 20. The transmit coil 11, the first communicator 12, the controller 13, and the indicator 14 are all located on a side of the bearing surface 151 away from the equipment to be charged. The prompt information includes a light projection 30 on the bearing surface 151, and the light projection 30 defines the placement position of the equipment 20 to be charged. For example, the bearing surface 151 is flat.

The embodiments of the present disclosure do not limit the positional relationship and assembling manner among the various components of the wireless charging device 10, such as the bearing surface 151, the transmit coil 11, the first communicator 12, the controller 13, and the indicator 14. In an example, as illustrated in FIG. 3A, the wireless charging device 10 includes a device body 15 having the bearing surface 151, the device body 150 includes a cavity 150, and the transmit coil 11, the first communicator 12, the controller 13, and the indicator 14 are all arranged in the cavity 150.

As illustrated in FIG. 3A, the indicator 14 includes a light-emitting element 141, the light-emitting element 141 is configured to emit light under the control of the controller 13 and project the light onto the bearing surface 151 to form the light projection 30, and the prompt information includes the light projection 30 formed by projecting the light emitted by the light-emitting element 141 onto the bearing surface 151. In this way, by means of light projection, the prompt information composed of light projection 30 is formed on the bearing surface 151 that is configured to support the equipment to be charged 20, thereby indicating the user to support the equipment to be charged in the region formed by the light projection 30, so as to achieve the alignment of the transmit coil 11 and the receive coil 21.

For example, FIG. 3A illustrates that the light-emitting element 141 projects light onto the bearing surface 151 from the side, away from the transmit coil 11, of the bearing surface 151. However, the embodiments of the present disclosure are not limited in this aspect, and the light-emitting element 141 can also project light onto the bearing surface 151 from the side, close to the transmit coil 11, of the bearing surface 151.

For example, the placement position of the equipment to be charged 20 is a rectangular region, and the light projection 30 includes at least two linear light projections to indicate at least two sides of the rectangular region, thereby defining the rectangular region.

For example, the light projection 30 indicates two adjacent sides of the rectangular region, and the user can determine the rectangular region according to the two adjacent sides and support the equipment to be charged so that the receive coil and the transmit coil are aligned.

For example, the light projection 30 indicates two opposite sides of the rectangular region, and the user can determine two opposite sides of the rectangular region according to the two opposite sides, such as the long sides or the short sides of the rectangular region. And then the positions of the other two sides of the rectangular region are roughly determined according to the two opposite sides. For example, the other two sides are symmetrical with respect to the two opposite sides that are determined.

In other examples, the light projection 30 indicates the four sides of the rectangular region. As illustrated in FIG. 3B, the user can directly support the equipment to be charged in the rectangular region to realize the alignment of the receive coil and the transmit coil.

For example, the prompt information includes placement direction information of the equipment to be charged, and the prompt information further indicates a placement direction of the equipment to be charged.

For example, the controller is further configured to acquire the placement direction information of the equipment to be charged according to the relative position information of the receive coil in the equipment to be charged, and control the indicator to send out prompt information including the placement direction information. For example, the light projection 30 further includes the placement direction information.

For example, at least two line light sources are respectively configured to emit light of different colors to form linear light projections of different colors to indicate the placement direction of the equipment to be charged 20, that is, the positions corresponding to different sides of the equipment to be charged 20. For example, the linear light projections of different colors respectively indicate the corresponding positions of different sides of the equipment to be charged 20. For example, when the receive coil 21 is not located at the center of the equipment to be charged 20, the placement direction of the equipment to be charged 20 needs to be determined.

For example, the light-emitting element 141 includes at least two line light sources, and the at least two line light sources are respectively configured to form the at least two linear light projections. A line light source refers to a light source that can emit parallel light, which can form a linear light projection on a projection surface.

It should be noted that the light source in the embodiments of the present disclosure includes a direct light source or a combination of a direct light source and a light guide element. For example, the line light source can include a light source capable of directly emitting parallel light, or a combination of a light source (such as an LED) and a light guide element.

For example, as illustrated in FIG. 3A, the number of line light sources 142 can be two, and the two line light sources 142 are symmetrically arranged on two sides of the device body 15, so as to indicate the placement position of the equipment to be charged 20 to some extent. The placement position can be a position which the short side or the long side of the equipment to be charged needs to be aligned with, depending on whether the two line light sources 142 are specifically arranged on two short sides or two long sides of the device body 15. The line light source and working mode thereof provided by the embodiments of the present disclosure are exemplarily described below in conjunction with the accompanying drawings, but they are not intended to limit the present disclosure.

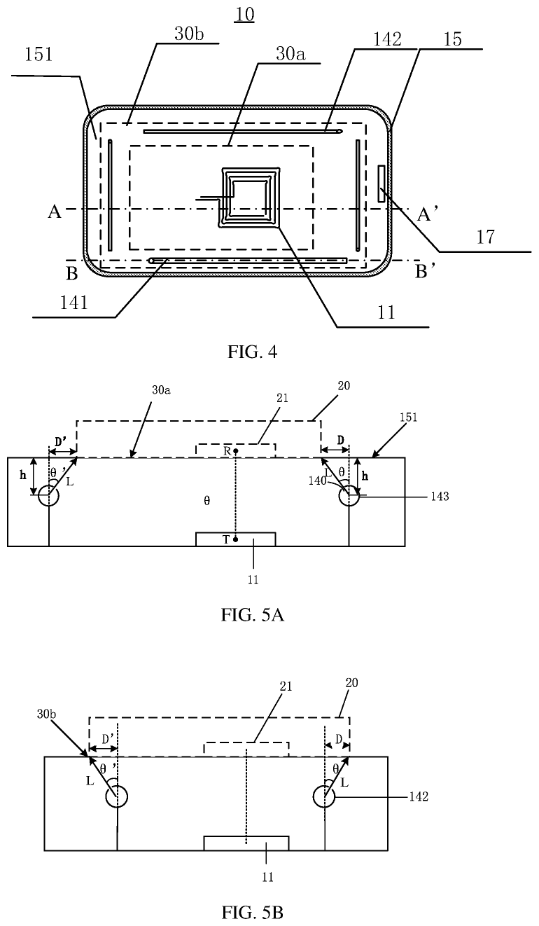

FIG. 4 illustrates a schematic plan view of a wireless charging device 10 provided by some other embodiments of the present disclosure. FIG. 5A-FIG. 5B are an example of a cross-sectional view of FIG. 4 along the section line AA′, and FIG. 5C is an example of a cross-sectional view of FIG. 4 along the section line BB′.

For example, as illustrated in FIG. 4, the light-emitting element 141 includes four line light sources 142, and the four line light sources 142 are respectively disposed on four sides of the device body 15, that is, each side of the device body 15 is provided with one line light source 142. In this way, the light projection 30 formed by the light emitted by the four line light sources 142 on the bearing surface 151 can form a rectangular region (as illustrated in FIG. 3B), and a light projection, whose shape is similar to the shape of the equipment to be charged, is better formed as the prompt information, which is more convenient for the user to operate. For example, the light projection can be inside the region enclosed by the orthographic projections of the four line light sources 142 on the bearing surface 151 (the light projection 30a illustrated in FIG. 4), the light projection can also be outside the region enclosed by the orthographic projections of the four line light sources 142 on the bearing surface 151 (the light projection 30b illustrated in FIG. 4), and the light projection can also be overlapped with the region enclosed by the orthographic projections of the four line light sources 142 on the bearing surface 151. The embodiments of the present disclosure are not limited in this aspect.

It should be noted that the light emitted by the line light source 142 can be colored. If necessary, in order to ensure the collimation of the light, a laser light source can be adopted to form the line light source.

In other examples, the line light source is composed of a strip-shaped light fixture, and the surface of the strip-shaped light fixture is provided with an opaque coating with a slit, and the slit is parallel to the length direction of the light fixture, so that light can be emitted only from the slit to form parallel light in a single direction. For example, the strip-shaped light fixture contains a plurality of LEDs arranged in a line.

In still other examples, with reference to FIG. 5A-FIG. 5C, each line light source 142 includes a light source 144 and a light guide pole 143. The axial direction (length direction) of the light guide pole is parallel to the bearing surface 151, the light source 144 is arranged at one end of the light guide pole 143, and the light emitted by the light source 144 enters from one end of the light guide pole 143 and uniformly exits from a side surface of the light guide pole 143. For example, the material of the light guide pole 143 is a transparent material, such as acrylic resin, polycarbonate, epoxy resin, glass, etc. For example, the light source 144 can be a light-emitting diode (LED).

The surface of the light guide pole 143 is provided with an opaque coating having a slit 140, and the slit 140 is parallel to the axial direction of the light guide pole 143, so that the light emitted from the side of the light guide pole is restricted to a single direction to form a line light source (parallel light).

In some examples, the indicator 14 further includes at least two rotators, the at least two rotators are arranged in one-to-one correspondence with the at least two line light sources 142, and each of the at least two rotators is configured to rotate a light guide pole 143 in the corresponding line light source 142 to change the light output direction of the corresponding line light source, thereby changing the position of the linear projection formed by the line light source on the bearing surface 151. For example, as illustrated in FIG. 5C, the rotator 145 corresponding to each light guide pole 143 is disposed at the other end of the light guide pole 143 away from the corresponding light source 144. For example, the rotator can be implemented as a motor.

FIG. 5A and FIG. 5B respectively illustrate schematic diagrams of the line light source, under the action of the rotator, projects the light L onto the bearing surface 151 from the side of the bearing surface 151 close to the transmit coil 11 (that is, in the cavity 150) to form the light projections 30 at different positions. In this case, in order to make the light L smoothly exit the cavity 150 to reach the bearing surface 151, the material of the bearing surface 151 can be transparent or semi-transparent.

As illustrated in FIG. 5A, the light projection can be located inside the region enclosed by the orthographic projections of the four line light sources 142 on the bearing surface 151 to form the light projection 30a as illustrated in FIG. 4; as illustrated in FIG. 5B, the light projection can also be located outside the region enclosed by the orthographic projections of the four line light sources 142 on the bearing surface 151 to form the light projection 30b as illustrated in FIG. 4.

For example, the controller 13 is configured to control each rotator 145 to rotate the corresponding line light source 142 according to the relative position information of the receive coil in the equipment to be charged, so as to change the position of the linear projection formed by the corresponding line light source on the bearing surface 151, thereby indicating the placement position of the equipment to be charged 20.

For example, the controller 13 is configured to generate a control instruction in combination with the relative position information of the receive coil to control the rotation angle of the light guide pole, so that the light projection formed on the plane matches the size of the equipment to be charged.

For example, the controller 13 can be configured to: calculate the position of the rectangular region of the edge contour of the equipment to be charged in the cartesian coordinate system with the center of the transmit coil as the coordinate origin in the case where the receive coil of the equipment to be charged is aligned with the transmit coil, according to the relative position information of the receive coil of the equipment to be charged and the relative position relationship of the transmit coil in the wireless charging device; and generate a control instruction for the line light source 142, the control instruction including an instruction for controlling the rotation angle of the line light source 142, so as to allow the light projection 30 formed by projecting onto the bearing surface 151 to form the rectangular region matching the size of the equipment to be charged. In this way, after the rectangular region is formed, the user puts the equipment to be charged into the rectangular region and fits the shape of the rectangular region to complete coil alignment.

FIG. 9 illustrates a calculation diagram of an alignment method of the receive coil and the transmit coil.

Xoy coordinate system is established with one corner of the wireless charging device as the coordinate origin and the position of the transmit coil (such as the center point) in the xoy coordinate system is determined; in addition, x′o′y′ coordinate system is established with one corner of the equipment to be charged as the coordinate origin and the position of the receive coil (such as the center point A) in the x′ o′y′ coordinate system is determined according to the relative position information of the receive coil, and the coordinate of point A in the x′o′y′ coordinate system is unified with the coordinate of the transmit coil 11 in the xoy coordinate system, so that the mapping relationship between the two coordinate systems can be obtained:

\vec{OO}′=\vec{OA}-\vec{O′A}.

Through the above mapping relationship, the coordinates of the edges (such as four sides) of the equipment to be charged in the xoy coordinate system, that is, the placement position of the equipment to be charged on the bearing surface 151 can be obtained.

After calculating the placement position of the equipment to be charged, the position of the light projection 30 to be formed by each line light source 142 on the bearing surface 151 can be obtained, and the corresponding rotation angle θ of the light guide pole can be calculated.

As illustrated in FIG. 5A and FIG. 5B, assuming that the initial position of the slit 140 on the light guide pole 143 is facing the bearing surface 151 (that is, at the top), the vertical distance from the light guide pole 143 to the bearing surface 151 is h.

When it is detected that the placement position is located inside the region enclosed by the orthographic projections of the four light guide poles 143 on the bearing surface 151, and D and D′ are respectively the shortest distance of the receive coil relative to the orthographic projection of the axis of each light guide pole 143 on the bearing surface 151, the controller 13 controls each rotator to rotate its corresponding light guide pole 143, and the rotation angle θ′ (clockwise) and 0 (counterclockwise) satisfy:

tan θ=D/h, tan θ′=D′/h.

When it is detected that the placement position is located outside the region enclosed by the orthographic projections of the four light guide poles 143 on the bearing surface 151, the controller 13 controls each rotator to rotate its corresponding light guide pole 143, and the rotation angle θ′ (counterclockwise) and 0 (clockwise) satisfy:

tan θ=D/h, tan θ′=D′/h.

In other examples, the light-emitting element 141 can project on the bearing surface 151 from a side of the bearing surface 151 away from the transmit coil 11. For example, the indicator 14 can further include a retractor, the retractor is connected to the light-emitting element 141 and allows the light-emitting element 141 to protrude relative to the bearing surface 151 and have a variable distance from the bearing surface 151.

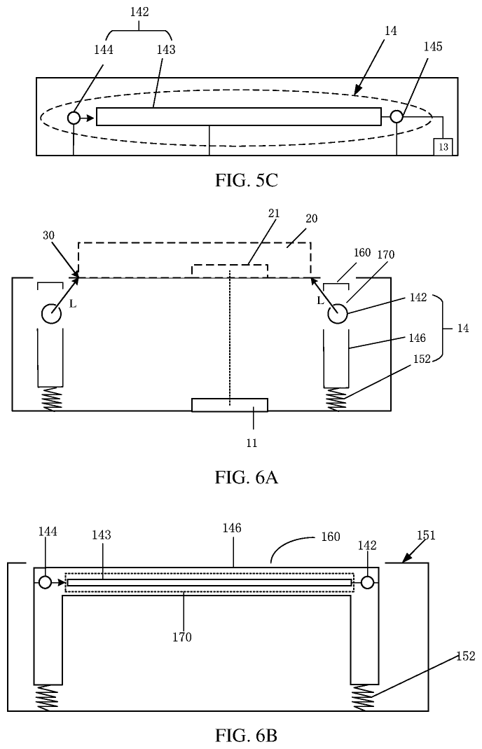

FIG. 6A and FIG. 6B are another example of the cross-sectional views of FIG. 4 along the section lines A-A′ and B-B′, respectively. As illustrated in the figures, the indicator 14 further includes a support shell 146 and a retractor 152 corresponding to each line light source 142. Each support shell 146 is used to accommodate and fix the corresponding line light source 142 and is connected to the corresponding retractor 152. The support shell 146 can protect the line light source 142. For example, the support shell 146 can be made of plastic, ceramic, metal, or other materials.

For example, the retractor 152 can be implemented as a retractable device such as a spring or a screw. For example, as illustrated in FIG. 6A and FIG. 6B, the retractor 152 includes two springs respectively connected to two ends of the support shell 146. When the spring is in a stretched state, the light-emitting element 141 can be caused to reach out of the device body 15 and rise to the side of the bearing surface 151 away from the cavity 150, and project on the bearing surface 151 from above the bearing surface 151. When the spring is in a compressed state, the light-emitting element 141 can be taken in the cavity 150, which is convenient to carry and more beautiful.

For example, the device body 15 is provided with a window 160 at a position corresponding to the support shell 146 to allow the support shell 146 to reach out.

For example, each support shell 146 has an opening 170 at a position corresponding to the light guide pole 142 to allow light to exit.

FIG. 6A-FIG. 6B illustrate schematic diagrams of that the light-emitting element 141 in the wireless charging device provided by the embodiment of the present disclosure projecting the light L on the bearing surface 151 to form the light projection 30 from the cavity 150.

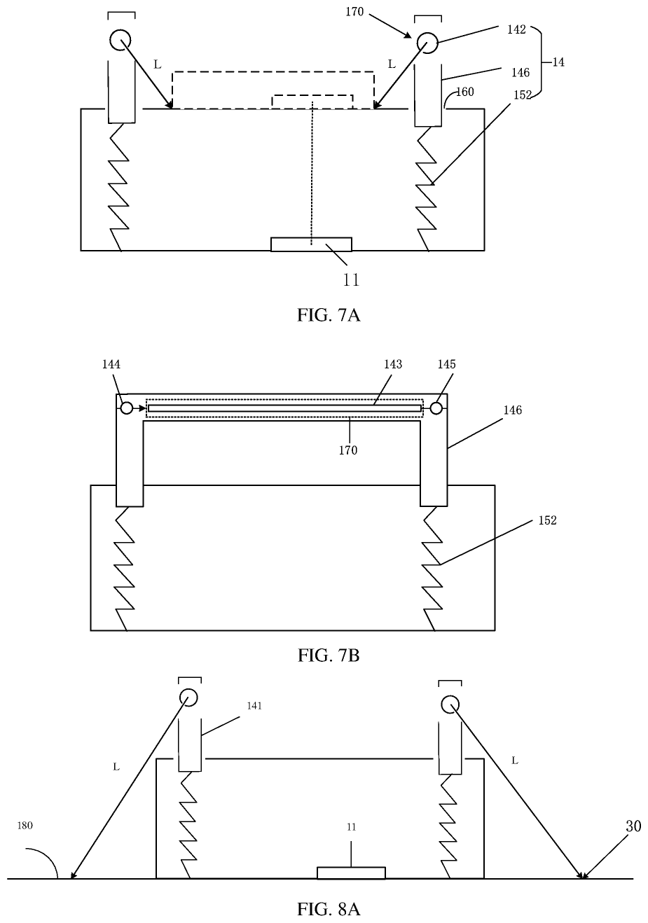

FIG. 7A-FIG. 7B illustrate schematic diagrams of that the light-emitting element 141 in the wireless charging device provided by the embodiment of the present disclosure projects the light L on the bearing surface 151 to form the light projection 30 from the side of the bearing surface 151 away from the cavity 150 (outside the cavity 150). In this case, the material of the bearing surface 131 can be opaque. When the spring is in a stretched state, the light-emitting element 141 can be caused to reach out of the device body 15 and rise to the side of the bearing surface 151 away from the cavity 150.

In this case, the calculation method of the rotation angle of the light guide pole (usually driven by a motor) is illustrated in FIG. 10.

As illustrated in FIG. 10, D and D′ are respectively the minimum distance of the receive coil relative to the orthographic projection of the axis of each light guide pole 143 on the bearing surface 151, h is the height of the light guide pole, and θ and θ′ are respectively the required rotation angles of the left and right light guide poles. Assuming that initially, the light-leaking part of the light guide pole (slit 140) is located at the bottom, then the rotation angle θ (clockwise) and θ′ (counterclockwise) of the light guide pole satisfy:

tan θ=D/h, tan θ′=D′/h.

Therefore, the rotation angle of the light guide pole can be calculated, and the motor is controlled to drive the light guide pole to rotate according to the rotation angle, thereby reminding the user of the placement position of the receive coil.

Of course, the above calculation method only schematically calculates the rotation angles of the light guide poles on both sides. In the case where the light guide poles are arranged on four sides of the wireless charging device, the rotation angles of the light guide poles on the other two sides can be obtained in the same way, which are not repeated here.

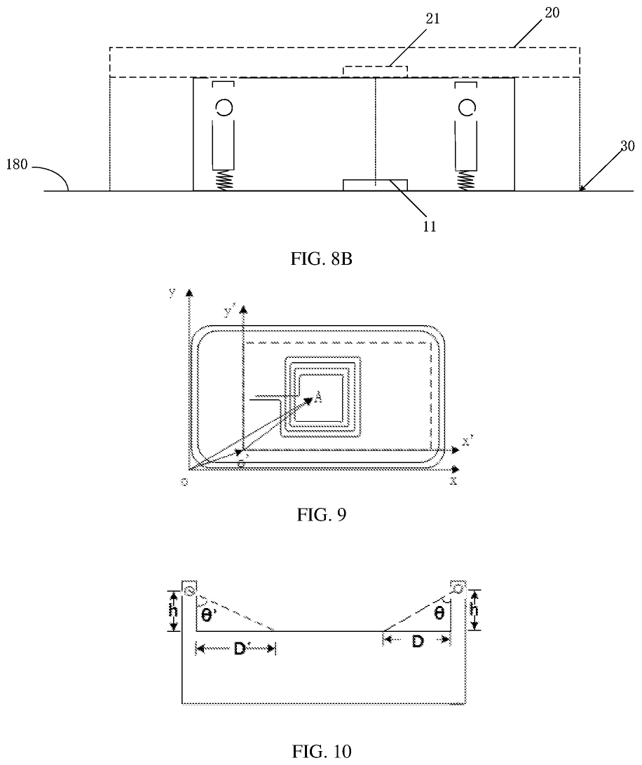

FIG. 8A and FIG. 8B illustrate another working schematic diagram of the wireless charging device, which is applicable in the case where the area of the equipment to be charged 20 is larger than the area of the bearing surface 151.

As illustrated in FIG. 8A, the light-emitting element 141 projects to the bearing surface 151 from the side of the bearing surface 151 away from the transmit coil 11. In the case where the light projection at least partially exceeds the bearing surface 151, the light projection 30 is formed on a surface of a support 180 carrying the wireless charging device 10 to indicate the placement position of the equipment to be charged 20. For example, it can wait for a certain time (such as 3 seconds) so that the user can recognize the light projection 30, and then the retractor 152 is shrunk under the control of the controller 13 so that the light-emitting element 141 is retracted below the bearing surface 151, for example, taken in the cavity 150, so as not to affect the placement of the equipment to be charged 20 on the bearing surface 151. The user can support the equipment to be charged 20 according to the position 30 of the light projection, thereby aligning the receive coil 21 with the transmit coil 11, as illustrated in FIG. 8B.

In this case, the rotation angle of the light guide pole can be referred to the foregoing embodiment, which will not be repeated here.

It should be noted that, because the light projection does not indicate the direction, when necessary, it is needed to additionally mark the placement direction of the equipment to be charged. For example, the orientation of the top end of the equipment to be charged is indicated by making the light guide poles emit different colors, or light-emitting elements are respectively directly provided at the positions of the wireless charging device close to the two short sides, and the orientation of the top end of the equipment to be charged is indicated by turning on the light-emitting element on one side. The top end here may refer to one end where the front camera of a mobile phone, a tablet computer, or the like, is placed, for example. In this way, by adding an indication of the placement direction, the equipment to be charged can be placed correctly when placed, so as to prevent the coil from being not aligned.

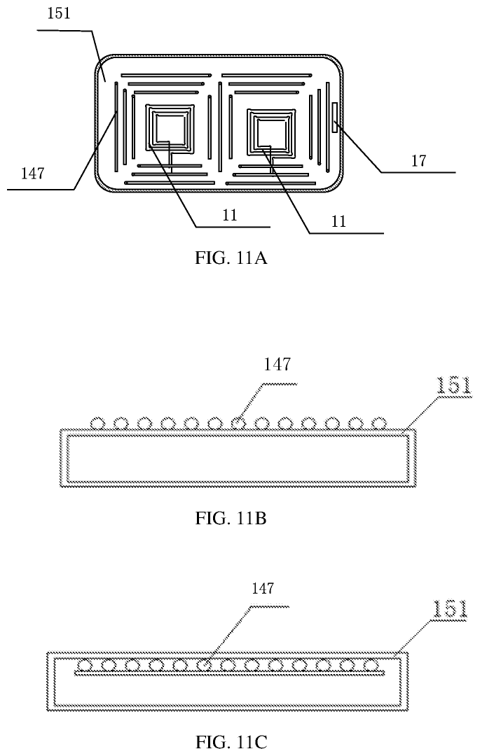

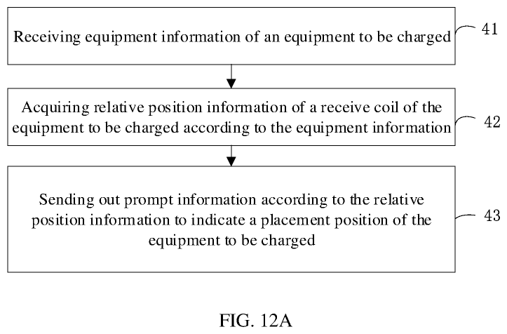

FIG. 11A is a schematic diagram of a wireless charging device provided by other embodiments of the present disclosure. For example, as illustrated in FIG. 11A, the wireless charging device can include a plurality of transmit coils 11, so that a plurality of equipment to be charged can be charged at the same time.

As illustrated in FIG. 11A, the indicator 14 further includes an auxiliary light-emitting element 147. For example, the auxiliary light-emitting element 147 is disposed on the bearing surface 151, configured to support the equipment to be charged 20, of the device body 15, and is configured to send out auxiliary prompt information. In this way, using the auxiliary light-emitting element 147 to send out auxiliary prompt information can better realize the prompt function and facilitate coil alignment. For example, the auxiliary light-emitting element 147 can have a structure similar to that of the light-emitting element 141.

The auxiliary prompt information described here can be auxiliary prompt information given on the basis of the prompt information sent out by the aforementioned light-emitting element 141. For example, the light emitted by the light guide pole may not be able to illuminate a position relatively close to the edge of the wireless charging device, and the auxiliary light-emitting element 147 provided at the position can be used to prompt; or the auxiliary light-emitting element can help prompt the placement direction of the equipment to be charged.

For example, in the case where the wireless charging device includes two or more transmit coils, more than two equipment to be charged can be charged at the same time, but the coils need to be aligned separately. However, the mutual blocking between the plurality of equipments to be charged may cause the problem that the light emitted by the light guide pole cannot be projected to the designated position. Therefore, as an alternative embodiment of the present disclosure, as illustrated in FIG. 11A, the auxiliary light-emitting element 147 is provided on the wireless charging device to solve the problem that the light of the light guide pole is blocked.

For example, a plurality of auxiliary light-emitting elements 147 may be arranged around each transmit coil 11, and the auxiliary light-emitting element 147 can be a dot-shaped or strip-shaped light-emitting element (such as a light-emitting diode LED). The dot-shaped light-emitting elements can be arranged in an array with the transmit coil as a center; and the strip-shaped light-emitting elements can be set as a group of four light-emitting elements to form a rectangle, and a plurality of rectangles form a nested arrangement, as illustrated in FIG. 11A. Optionally, the control instruction can further include the instruction to control the lighting of the corresponding light-emitting element (assuming that the initial state of the light-emitting element is a turn-off state), and the illuminated light-emitting element is configured to provide corresponding auxiliary prompt information.

For example, the controller 13 can further be specifically configured to: calculate the position of the rectangular region of the edge contour of the equipment to be charged in the cartesian coordinate system with the center of the transmit coil as the coordinate origin when the receive coil of the equipment to be charged is aligned with the transmit coil, according to the relative position information of the receive coil of the equipment to be charged and in combination with the relative position relationship between the indicator and the transmit coil; and generate a lighting instruction of at least one auxiliary light-emitting element 147 located at the boundary of the rectangular region to light up the corresponding auxiliary light-emitting element 147 to indicate the placement position of the equipment to be charged.

For example, the transmit coil 10, the first communicator 20, and the controller 30 can be arranged in the cavity 150 of the device body 15. The auxiliary light-emitting element 147 can be arranged outside the device body 15, and can also be arranged in the cavity 150 of the device body 15.

FIG. 11B illustrates a cross-sectional view of the wireless charging device. The auxiliary light-emitting element 147 can be arranged on the bearing surface 151, configured to support the equipment to be charged, of the device body 15. FIG. 11C illustrates another cross-sectional view of the wireless charging device. The auxiliary light-emitting element 147 can also be arranged under the bearing surface 151, configured to support the equipment to be charged, of the device body 15.

In the case where the auxiliary light-emitting element 147 is arranged under the bearing surface 151, the bearing surface 151 can be transparent or semi-transparent in order to enable light to be emitted outside the device body 15. When the bearing surface 151 is semi-transparent, the auxiliary light-emitting element 147 needs to be as close as possible to the bearing surface 151 so that light can be emitted outside the device body 15 to the greatest extent. Meanwhile, it can be seen that in the case where the auxiliary light-emitting elements 147 are arranged in the device body 15, the arrangement of the auxiliary light-emitting elements 147 do not affect the placement of the equipment to be charged; in addition, in the case where the bearing surface 151 is in a semi-transparent state, the shape and contour of the auxiliary light-emitting element 147 can be blurred to a certain extent, thereby making the appearance of the wireless charging device more beautiful.

For example, as illustrated in FIG. 1 and FIG. 3A, the wireless charging device 10 further includes a memory 16, which is configured to store the relative position information of the receive coil 21 of the equipment to be charged 20. The relative position information of the receive coil and the equipment information of the equipment to be charged 20 are associated with each other.

For example, the memory can include any combination of one or more computer program products, and the computer program product can include various forms of computer-readable storage media, such as volatile memory and/or non-volatile memory. The volatile memory can include, for example, random access memory (RAM) and/or cache memory (cache), etc. The non-volatile memory can include, for example, read only memory (ROM), hard disk, erasable programmable read only memory (EPROM), portable compact disk read only memory (CD-ROM), USB memory, flash memory, etc.

For example, the memory can be a memory inside the controller, or can be set separately from the controller.

For example, the controller 13 is configured to acquire the relative position information of the receive coil from the memory; or, control the first communicator to acquire the relative position information of the receive coil from the network according to the equipment information of the equipment to be charged.

For example, after the controller 13 receiving the equipment information of the equipment to be charged 20 from the first communicator, the controller 13 can retrieve the relative position information of the receive coil associated with the equipment information from the local memory 16, and then process and obtain the corresponding control instruction to enable the indicator 14 to send out prompt information.

For example, in the case where the relative position information of the receive coil associated with the acquired equipment information of the equipment to be charged is not stored in the memory 16, the controller 13 controls the first communicator to acquire the relative position information of the receive coil from the network according to the equipment information of the equipment to be charged, so as to acquire the relative position information of the receive coil. For example, the controller 13 can also store the relative position information of the receive coil acquired from the network in the memory 16.

For example, as illustrated in FIG. 1 and FIG. 3A, the first communicator 12 is further configured to acquire the relative position information of the receive coil 21 of the equipment to be charged 20 from the network according to the equipment information of the equipment to be charged 20.

For example, the first communicator 12 obtains the most likely relative position of the receive coil of the equipment to be charged, according to equipment information of the equipment to be charged, by querying the network or analyzing big data.

In this way, by acquiring relative position information from the network, any type of equipment to be charged can be obtained from the network as long as the relative position information of its receive coil is disclosed on the network, which improves the versatility of the wireless charging device.

For example, the first communicator 12 can also be configured to acquire the size and shape information of the equipment to be charged 20 and the relative position information of the receive coil from the network according to the equipment information of the equipment to be charged 20.

For example, in the case where the relative position information of the receive coil associated with the acquired equipment information of the equipment to be charged is not stored in the memory 16, the controller 13 controls the first communicator to acquire the relative position information of the receive coil of the equipment to be charged from the network according to the equipment information of the equipment to be charged, so as to acquire the relative position information of the receive coil. For example, the controller 13 can also store the relative position information acquired from the network in the memory 16.

For example, the memory 16 can also be configured to store the relative position information of the receive coil of the equipment to be charged 20 acquired from the network.

In addition, in the case where the storage function of the memory 16 and the network acquisition function of the first communicator 12 are combined, the memory 16 and the first communicator 12 can complement each other, which further improves the versatility of the wireless charging device. For example, in a technical solution of that local retrieval is prior to network acquisition, in the case where the size information and relative position information are not stored in the memory 16, the first communicator 12 can be used to acquire the size information and relative position information from the network; or, in a technical solution of that network acquisition is prior to local retrieval, in the case where the first communicator 12 cannot acquire the size information and relative position information from the network, available information can be searched from the local memory 16.

For example, as illustrated in FIG. 1, FIG. 3A and FIG. 3B, the wireless charging device 10 further includes a sensor 17, which is configured to sense whether the equipment to be charged 20 approaches the wireless charging device 10. The first communicator 12 is further configured to acquire the equipment information of the equipment to be charged 20 from the equipment to be charged 20 when the equipment to be charged 20 approaches the wireless charging device 10.

In this way, by monitoring sensor data collected by the sensor 17, it is determined whether the equipment to be charged 20 approaches. If so, it means that the equipment to be charged needs to be charged. The first communicator 12 establishes communication with the equipment to be charged and acquires the equipment information of the equipment to be charged to obtain the size information and relative position information according to the equipment information. For example, the sensor 17 can be a pressure sensor, which is configured to detect whether the equipment to be charged is placed on the bearing surface 151 by detecting a pressure change on the bearing surface 151. For example, the sensor 17 is a photoelectric sensor, which is configured to detect whether the equipment to be charged is placed on the bearing surface 151 by detecting a light change on the bearing surface 151. For example, the sensor 17 can also include a contact switch or the like. The embodiments of the present disclosure do not limit the specific implementation of the sensor 17.

In other examples, for example, the first communicator 12 can also serve as the sensor to detect whether the equipment to be charged approaches. For example, when the equipment to be charged approaches, the first communicator 12 can acquire the equipment information of the equipment to be charged, such as a physical address (MAC address), etc., and the approach of the equipment to be charged is detected. For example, the first communicator 12 can also determine whether the equipment to be charged approaches according to the received signal strength indication (RSSI).

At least one embodiment of the present disclosure further provides a wireless charging method, which is suitable for the above-mentioned wireless charging device, and the method can solve the alignment problem of the wireless charging coil to some extent.

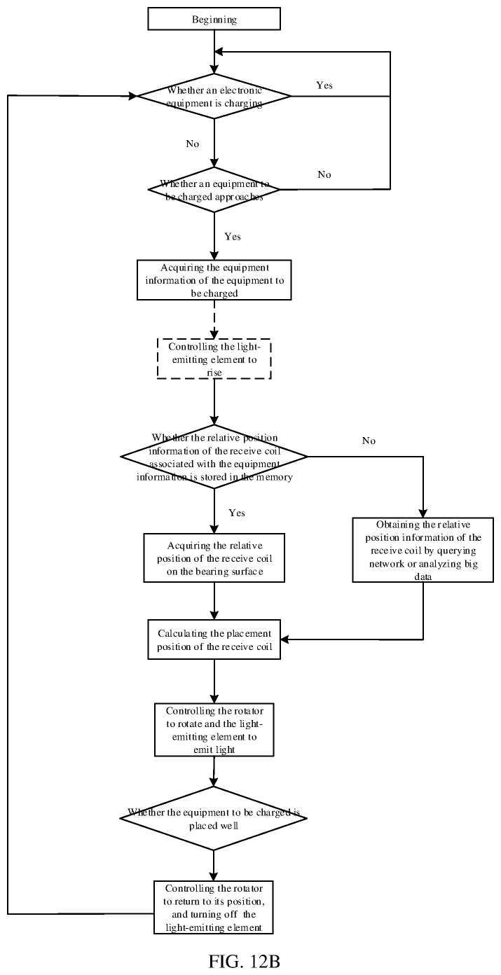

As illustrated in FIG. 12A, the wireless charging method includes the following steps: Step 41: receiving equipment information of an equipment to be charged; Step 42: acquiring relative position information of a receive coil of the equipment to be charged according to the equipment information; and Step 43: sending out prompt information according to the relative position information to indicate a placement position of the equipment to be charged.

For example, the relative position information refers to the position of the receive coil 21 in the equipment to be charged 20, and can also be understood as information of a certain coordinate position where the receive coil 21 is located in a coordinate system that is established with the center of the equipment to be charged 20 as the coordinate origin. For example, as illustrated in FIG. 2, the relative position information can also refer to the distances d1, d2, d3, and d4 between the center of the receive coil 21 and the four sides of the equipment to be charged 20. Optionally, the size information and relative position information can be retrieved by the wireless charging device from its local memory or obtained from the network according to the equipment information.

It can be seen from the above embodiments that, the wireless charging method of the wireless charging device provided by the embodiments of the present disclosure acquires the corresponding relative position information by receiving the equipment information of the equipment to be charged, then combines with the relative position relationship between the indicator and the transmit coil, for the purpose of aligning the transmit coil and the receive coil, generates the control instruction for the indicator, and controls the indicator to send out prompt information to indicate the placement position of the equipment to be charged; in this way, when the user places the equipment to be charged at the placement position, coil alignment can be achieved, thereby improving the charging efficiency.

For example, sending out prompt information according to the relative position information of the receive coil includes: controlling a light-emitting element to emit light and project the light onto a bearing surface, for placing the equipment to be charged, of the wireless charging device to form a light projection according to the relative position information, the light projection defining the placement position of the equipment to be charged.

For example, the placement position of the equipment to be charged is a rectangular region, the light-emitting element comprises at least two line light sources, and controlling the light-emitting element to emit light and project the light onto the bearing surface, for placing the equipment to be charged, of the wireless charging device to form the light projection according to the relative position information of the receive coil includes: controlling the at least two line light sources to form at least two linear projections on the bearing surface to indicate at least two sides of the rectangular region.

For example, controlling the at least two line light sources to form at least two linear projections on the bearing surface to indicate at least two sides of the rectangular region includes: controlling the at least two line light sources to rotate according to the relative position information of the receive coil, so as to change light output directions of the at least two line light sources and positions of the linear projections formed on the bearing surface, thereby indicating the placement position of the equipment to be charged.

For example, controlling the light-emitting element to emit light and project the light onto the bearing surface, for placing the equipment to be charged, of the wireless charging device to form the light projection according to the relative position information of the receive coil further includes: controlling the at least two line light sources to emit lights of different colors to indicate a placement direction of the equipment to be charged.

For example, acquiring the relative position information of the receive coil according to the equipment information further includes: in the case where the relative position information of the receive coil associated with the acquired equipment information of the equipment to be charged is stored in a memory, acquiring the relative position information of the receive coil from the memory; and in the case where the relative position information of the receive coil associated with the acquired equipment information of the equipment to be charged is not stored in the memory, controlling the first communicator to acquire the relative position information of the receive coil from the network according to the equipment information of the equipment to be charged.

As an embodiment of the present disclosure, the wireless charging method can further include: sensing whether the equipment to be charged 20 approaches the wireless charging device 10; and acquiring the equipment information of the equipment to be charged 20 from the equipment to be charged 20 in the case where the equipment to be charged 20 approaches the wireless charging device 10.

In this way, in the case where it is detected that the equipment to be charged approaches, it is determined that the equipment to be charged currently needs to be charged, and equipment information of the equipment to be charged is obtained immediately, which can improve the overall work efficiency and intelligence of the device.

For example, as illustrated in FIG. 3A, the wireless charging device 10 further includes the device body 15 that includes the bearing surface 151 configured to support the equipment to be charged 20. The indicator 14 includes the light-emitting element 141, and the prompt information includes the light projection 30 formed by the light emitted by the light-emitting element 141 projected onto the bearing surface 151. The wireless charging method further includes: controlling the rotation angle of the light-emitting element 141 so that the light projection 30 formed on the bearing surface 151 can indicate the placement position of the equipment to be charged 20.

For example, the wireless charging method further includes: acquiring the size information of the equipment to be charged according to the equipment information; and generating the control instruction in combination with the size information to control the rotation angle of the light guide pole, so that the light projection formed on the plane matches the size of the equipment to be charged.

For example, the wireless charging device further includes the memory 16, and the wireless charging method further includes: acquiring the relative position information of the receive coil 21 of the equipment to be charged 20 from the memory 16 of the wireless charging device 10.

In this way, after the equipment information of the equipment to be charged 20 is received, the corresponding relative position information can be retrieved from the local memory 16, and then corresponding relative position information is processed to obtain the corresponding control instruction to cause the indicator 14 to send out prompt information.

For example, the memory 16 can further store size information of the equipment to be charged 20.

As another optional embodiment, the wireless charging method further includes: acquiring the relative position information of the receive coil 21 of the equipment to be charged 20 from the network according to the equipment information of the equipment to be charged 20.

In this way, by acquiring relative position information from the network, any type of equipment to be charged can be obtained from the network as long as the relative position information of its receive coil is disclosed on the network, which improves the versatility of the wireless charging device.

For example, the wireless charging method further includes: acquiring the size information of the equipment to be charged 20 from the network according to the equipment information of the equipment to be charged 20.

In addition, in the case where the storage function and the network acquisition function are simultaneously combined, the storage function and the network acquisition function can complement each other, which further improves the versatility of the wireless charging device. For example, in a technical solution of that local retrieval is prior to network acquisition, in the case where the size information and relative position information are not stored in the memory 16, the relevant information can be retrieved from the network; or, in a technical solution of that network acquisition is prior to local retrieval, in the case where the size information and relative position information cannot be acquired from the network, the available information can be searched from the local memory 16.

For example, the device body 15 further includes a retractor 152, and the retractor 152 is configured to support the light-emitting element 141 and to allow the light-emitting element 141 to be retractable relative to the device body 15 and to be taken in the device body 15. Furthermore, the wireless charging method can further include: controlling a corresponding driving mechanism to raise the light-emitting element 141 after acquiring the equipment information; and controlling the corresponding driving mechanism to retract the light-emitting element 141 when it is detected that the receive coil of the equipment to be charged is separated from the transmit coil or the equipment to be charged leaves the wireless charging device.

FIG. 12B is a schematic flowchart of a wireless charging method provided by another embodiment of the present disclosure. The wireless charging method will be schematically described below with reference to FIG. 4, FIG. 5A-FIG. 5C, FIG. 6A-FIG. 6B, FIG. 7A-FIG. 7B, and FIG. 8A-FIG. 8B.

For example, at the beginning, it is queried whether the sensor detects that an electronic equipment is charging, and if yes, the detection process is repeated; if not, it is detected whether an equipment to be charged approaches, and if yes, the first communicator is controlled to acquire equipment information of the equipment to be charged from the equipment to be charged. When the light-emitting element needs to be projected down from the bearing surface (as illustrated in FIG. 7A-FIG. 7B and FIG. 8A-FIG. 8B), the retractor can be controlled to raise the light-emitting element to a certain height above the bearing surface. Then, it is queried whether the relative position information of the receive coil associated with the equipment information of the equipment to be charged is stored in the memory. In the case where the equipment information of the equipment to be charged associated with the acquired relative position information of the receive coil is stored in the memory, the relative position information of the receive coil is acquired from the memory; and in the case where the equipment information of the equipment to be charged associated with the acquired relative position information of the receive coil is not stored in the memory, the first communicator is controlled to acquire relative position information of the receive coil, according to the equipment information of the equipment to be charged, from the network or by analyzing big data.

After obtaining the relative position information of the receive coil of the equipment to be charged, the placement position of the receive coil is calculated according to the calculation method illustrated in FIG. 9, and then the rotator is controlled to rotate the light guide pole and the light-emitting element is controlled to emit light to form the light projection indicating the placement position. When it is detected the equipment to be charged is placed well, the rotator can be controlled to return to its position, for example, the light guide pole is caused to return to the initial position and the light source is turned off.

In the situation illustrated in FIG. 8A-FIG. 8B, after the light projection is formed, the retractor can also be controlled to retract into the device body.

The embodiments of the present disclosure further provide an electronic equipment, which can solve the alignment problem of the wireless charging coil to a certain extent.

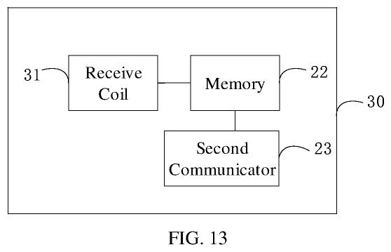

As illustrated in FIG. 13, the electronic equipment 30 includes: a memory 22 configured to store equipment information of the electronic equipment 30; and a second communicator 23 configured to send the equipment information to the wireless charging device 10.

It can be seen from the above-mentioned embodiments that, the electronic equipment provided by the embodiment of the present disclosure can send its own equipment information to the wireless charging device, so that the wireless charging device can acquire corresponding size information and relative position information, and then indicate the placement position, so that the receive coil can be aligned with the transmit coil of the wireless charging device to improve the charging efficiency.

For example, the electronic equipment is, for example, the equipment to be charged 20 in the foregoing embodiments.

For example, the electronic equipment can be a mobile phone, a tablet computer, or other equipment that support wireless charging, or other electronic equipment that can support wireless charging.

The embodiments of the present disclosure further provide a wireless charging system, which can solve the alignment problem of the wireless charging coil to a certain extent.

The wireless charging system includes the embodiment of the electronic equipment described above and any embodiment of the wireless charging device 10 described above, or any combination of the embodiments.

It can be seen from the above embodiments that, the wireless charging system provided by the embodiments of the present disclosure acquires the corresponding size information and the relative position information by receiving the equipment information of the equipment to be charged, and then combines the relative position relationship between the indicator and the transmit coil, for the purpose of aligning the transmit coil and the receive coil, generates the control instruction of the indicator, and controls the indicator to send out prompt information to indicate the placement position of the equipment to be charged; in this way, when the user places the equipment to be charged at the placement position, coil alignment can be achieved, thereby improving the charging efficiency.

It should be noted that in the wireless charging system, the wireless charging device can be sold or serve as a gift while selling the electronic equipment. However, based on the characteristics of the wireless charging device and the electronic equipment itself in the embodiments of the present disclosure, the electronic equipment is also compatible with other wireless charging devices, and the wireless charging device is also compatible with other electronic equipment, so the two can exist as separate products.

What have been described above are only specific implementations of the present disclosure, the protection scope of the present disclosure is not limited thereto, and the protection scope of the present disclosure should be based on the protection scope of the claims.

1. A wireless charging device, comprising:
a transmit coil;
a first communicator, configured to receive equipment information of an equipment to be charged;
an indicator; and
a controller, configured to acquire relative position information of a receive coil of the equipment to be charged according to the equipment information, and control the indicator to send out prompt information according to the relative position information to indicate a placement position of the equipment to be charged.

2. The device according to claim 1, further comprising a bearing surface, wherein
the bearing surface is used to support the equipment to be charged;
the prompt information comprises a light projection on the bearing surface, and the light projection is used to define the placement position of the equipment to be charged.

3. The device according to claim 2, wherein the indicator comprises a light-emitting element which is configured to emit light under control of the controller and project the light onto the bearing surface to form the light projection.

4. The device according to claim 3, wherein the placement position of the equipment to be charged is a rectangular region, and the light projection comprises at least two linear light projections to indicate at least two sides of the rectangular region; and
the light-emitting element comprises at least two line light sources, and the at least two line light sources are respectively configured to form the at least two linear light projections.

5. The device according to claim 4, wherein the at least two line light sources are respectively configured to emit light of different colors to indicate a placement direction of the equipment to be charged.

6. The device according to claim 4, wherein each of the at least two line light sources comprises a light guide pole, and the light guide pole is arranged parallel to the bearing surface; and
a surface of the light guide pole is provided with an opaque coating having a slit, so that light emitted from the light guide pole is restricted to a single direction to form the line light source.

7. The device according to claim 4, wherein the indicator further comprises at least two rotators, the at least two rotators are arranged in a one-to-one correspondence with the at least two line light sources, and each of the at least two rotators is configured to rotate a corresponding line light source to change a light output direction of the corresponding line light source; and
the controller is further configured to control each of the at least two rotators to rotate the corresponding line light source according to the relative position information of the receive coil, so as to change a position of a linear projection formed by the corresponding line light source on the bearing surface, thereby indicating the placement position of the equipment to be charged.

8. The device according to claim 3, wherein the light-emitting element is configured to project light from a side, close to the transmit coil, of the bearing surface to the bearing surface to form the light projection.

9. The device according to claim 3, wherein the light-emitting element is configured to project light from a side, away from the transmit coil, of the bearing surface to the bearing surface to form the light projection.

10. The device according to claim 9, wherein the indicator further comprises a retractor, and the retractor is located on a side, close to the transmit coil, of the bearing surface; and
the retractor is connected to the light-emitting element and allows the light-emitting element to protrude relative to the bearing surface and to have a variable distance from the bearing surface.

11. The device according to claim 3, further comprising a device body having the bearing surface, wherein
the device body comprises a cavity, and the cavity is used for accommodating the transmit coil, the first communicator, the controller, and the indicator.

12. The device according to claim 1, wherein the controller is configured to:
acquire the relative position information of the receive coil of the equipment to be charged from a memory, wherein the memory is configured to store the equipment information of the equipment to be charged and the relative position information, associated with the equipment information, of the receive coil; or
control the first communicator to acquire the relative position information of the receive coil of the equipment to be charged from a network according to the equipment information of the equipment to be charged.

13. The device according to claim 1, further comprising a sensor, wherein
the sensor is configured to sense whether an equipment to be charged approaches the wireless charging device; and
the first communicator is further configured to acquire the equipment information of the equipment to be charged from the equipment to be charged in a case where the equipment to be charged approaches the wireless charging device.

14. A wireless charging method, comprising:
receiving equipment information of an equipment to be charged;
acquiring relative position information of a receive coil of the equipment to be charged according to the equipment information; and
sending out prompt information according to the relative position information to indicate a placement position of the equipment to be charged.

15. The method according to claim 14, wherein sending out prompt information according to the relative position information comprises:
controlling a light-emitting element to emit light and project the light onto a bearing surface, for placing the equipment to be charged, of the wireless charging device to form a light projection according to the relative position information of the receive coil,
wherein the light projection defines the placement position of the equipment to be charged.

16. The method according to claim 15, wherein the placement position of the equipment to be charged is a rectangular region, and the light-emitting element comprises at least two line light sources;
controlling the light-emitting element to emit light and project the light onto the bearing surface, for placing the equipment to be charged, of the wireless charging device to form the light projection according to the relative position information of the receive coil comprises:
controlling the at least two line light sources to form at least two linear projections on the bearing surface to indicate at least two sides of the rectangular region.

17. The method according to claim 16, wherein controlling the at least two line light sources to form at least two linear projections on the bearing surface to indicate at least two sides of the rectangular region comprises:
controlling the at least two line light sources to rotate according to the relative position information of the receive coil, so as to change light output directions of the at least two line light sources and positions of the linear projections formed on the bearing surface, thereby indicating the placement position of the equipment to be charged.

18. The method according to claim 16, wherein controlling the light-emitting element to emit light and project the light onto the bearing surface, for placing the equipment to be charged, of the wireless charging device to form the light projection according to the relative position information of the receive coil further comprises:
controlling the at least two line light sources to emit light of different colors to indicate a placement direction of the equipment to be charged.

19. The method according to claim 14, wherein acquiring the relative position information of the receive coil according to the equipment information further comprises:
acquiring the relative position information of the receive coil of the equipment to be charged from a memory; or
controlling a first communicator to acquire the relative position information of the receive coil of the equipment to be charged from a network according to the equipment information of the equipment to be charged.

20. The method according to claim 14, further comprising:
sensing whether an equipment to be charged approaches the wireless charging device; and
acquiring the equipment information of the equipment to be charged from the equipment to be charged in a case where the equipment to be charged approaches the wireless charging device.
